(19) United States
(12) Patent Application Publication
(10) Pub. No.: US 2026/0217465 A1
(43) Pub. Date: Jul. 30, 2026

(54) WAREHOUSE EXECUTION SYSTEM, DEVICES, AND METHOD

(71) Applicant: SYSTEMEX AUTOMATION INC., Laval (CA)

(72) Inventors: Kelsey Medeiros, Laval (CA); Robert Battaglia, Laval (CA)

(21) Appl. No.: 19/147,571

(22) PCT Filed: Jan. 11, 2024
(86) PCT No.: PCT/CA2024/050029

§ 371 Date: Jul. 11, 2025

Related U.S. Application Data
(60) Provisional application No. 63/438,927, filed on Jan. 13, 2023.

(51) Int. Cl. B65G 1/137; G06Q 10/087

(52) U.S. Cl. CPC B65G 1/1378; G06Q 10/08741

(57) ABSTRACT

Distribution centers can be heavily dependent on human labor to prepare shipping cases that contain the customer products. The disclosure provides an automated system, comprising a control entity including a data processor for receiving via data communication over a data network a customer order, the customer order identifying a plurality of different products being ordered, a packing cell having a robotic arm, and a plurality of autonomous mobile robots, wherein the control entity releases instructions to the plurality of autonomous mobile robots such that selected autonomous mobile robots retrieve and bring a plurality of master cases to the packing cell, each master case of the plurality of master cases holding a plurality of identical products, and wherein the control entity releases instructions to the packing cell to direct the robotic arm to pick and place one or more products from the plurality of master cases into a shipping case.

### CROSS-REFERENCE TO RELATED APPLICATION

The present application claims the benefit of U.S. provisional patent application Ser. No. 63/438,927 filed on Jan. 13, 2023. The contents of the above-referenced document are incorporated herein by reference in their entirety.

### TECHNICAL FIELD

The present disclosure relates to supply chain, manufacturing and logistics automation equipment system, devices and method. More specifically, the present disclosure relates to an automated system, devices and method for processing customer product orders for picking and packaging product items into shipping cases for shipment to customers.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

Warehouses are typically buildings for storing goods and merchandise, used by manufacturers, importers, exporters, wholesalers, transport businesses, customs, distribution centers, etc. Stored goods can include any raw materials, packing materials, spare parts, components, or finished goods associated with various industries, such as for example agriculture, manufacturing, and production. Managing and operating warehouse can be heavily dependent on human labor for preparing shipping cases (e.g., bags, boxes, etc.) that contain products for shipping to customers, even more so in the specific case of fulfillment centers. Fulfillment centers (also referred in this text as distribution centers) are warehouses that process and fulfill customer orders, such as orders placed online (i.e., e-commerce).

Warehouses and distribution centers (particularly fulfillment centers) can be heavily dependent on human labor to prepare shipping cases (also referred to as custom fulfillment packages in fulfillment centers) that contain the customer products. FIG. 1 conceptually illustrates a storage zone 510 in a distribution site. The storage zone 510 typically includes a plurality of shelf racking 515 located throughout the storage zone 510. Each shelf racking in the plurality of shelf racking 515 can be several feet or stories high with several rows or racks. On each row or rack are several master cases 520 where each master case stores quantities of the same item. For example, in the case of an e-commerce based fulfillment center, once an order via an online ordering system is received, a person typically needs to pick the articles that the customer wants from the corresponding master case 520 in the distribution center and place them by hand in a shipping case. For example, when the order contains a set of different products (i.e., different Stock Keeping Unit (SKU)), the person needs to locate the corresponding master case 520 associated with each article in the set of different products, take the article out of the respective master case 520 and then put the article in a shipping case.

Distribution centers are vast areas, and locating the correct master case may be time-consuming for a person. Accordingly, an order with a large number of different articles will require significant time to put together as the person packing the shipping case needs to go to several master cases, which may be located in different places of the distribution center. Also, this process is prone to error as the person packing the shipping case may place the wrong article in the package.

Accordingly, there is a need to provide automated solutions for warehouses and distribution centers that reduce reliance on human labor for processing customer orders.

### SUMMARY

This Summary is provided to introduce a selection of concepts in a simplified form that are further described below in the Detailed Description. This Summary is not intended to identify key aspects or essential aspects of the claimed subject matter.

In a broad aspect, the disclosure relates to an automated system for use in a distribution center. For example, to fulfill customer orders in a completely automated fashion. For example, the system includes a control entity that receives a customer order via data communication over a data network and communicates with an autonomous mobile robot system to fulfill the customer order. The autonomous mobile robot system may include a packing cell having a robotic arm and a plurality of autonomous mobile robots. For example, the control entity can release instructions to the plurality of autonomous mobile robots such that selected autonomous mobile robots retrieve and bring a plurality of master cases to the packing cell, each master case of the plurality of master cases holding a plurality of identical products. For example, the control entity can also release instructions to the packing cell to direct the robotic arm to pick and place one or more products from the plurality of master cases into a shipping case.

Advantageously, the control entity controls and prioritizes autonomous mobile robots operations (e.g., displacement throughout the distribution center) to efficiently process a plurality of customer orders in a concerted fashion.

In a broad non-limiting aspect, the disclosure relates to a packing cell configured for selective communication with a control entity via a communication network. The packing cell being further configured to receive a plurality of master cases, each master case of the plurality of master cases holding a plurality of identical products. Wherein the packing cell includes a robotic arm. Wherein in response to instructions received from the control entity, the robotic arm is configured to pick and remove one or more products corresponding to the customer order from a relevant master case of the plurality of master cases and place into a shipping case.

In a broad non-limiting aspect, the disclosure relates to plurality of autonomous mobile robots configured for selective communication with a control entity via a communication network. Wherein in response to instructions received from the control entity, selected autonomous mobile robots of the plurality of autonomous mobile robots are configured to navigate in the distribution center to bring a respective master case to a packing cell, or to position in proximity to the packing cell to receive in the shipping case the one or more products picked by the robotic arm.

In a broad non-limiting aspect, the disclosure relates to a system for use in a distribution center, the system comprising: a) a control entity including a data processor for receiving via data communication over a data network a customer order, the customer order identifying a plurality of different products being ordered, b) a packing cell configured to receive a plurality of master cases, each master case of the plurality of master cases holding a plurality of identical products, wherein the packing cell includes a robotic arm, wherein in response to instructions received from the control entity, the robotic arm is configured to pick and remove one or more products corresponding to the customer order from a relevant master case of the plurality of master cases and place into a shipping case, c) a plurality of autonomous mobile robots, wherein in response to instructions received from the control entity, selected autonomous mobile robots of the plurality of autonomous mobile robots are configured to navigate in the distribution center to bring a respective master case to the packing cell, or to position in proximity to the packing cell to receive in the shipping case the one or more products picked by the robotic arm.

In some non-limiting embodiments, the system may include one or more of the following features:
the packing cell is in selective communication with the control entity via a communication network.
the plurality of autonomous mobile robots is in selective communication with the control entity via a communication network.
the control entity receives a plurality of customer orders.
the control entity implements an ordering logic configured to receive and process the plurality of customer orders to obtain a corresponding plurality of order transactions.
the control entity processes the plurality of order transactions to fulfill the corresponding plurality of customer orders based on an optimization computation of resources properties.
the resources properties includes location of a master case containing a desired product unit, congestion in the distribution center, charge level of autonomous mobile robots, or status of the packing cell.
the control entity implements a packing arrangement logic to compute and determine a sequence for placing the one or more products in the shipping case.
the packing arrangement logic defines a position of each product in the shipping case.
the sequence for placing the one or more products in the shipping case determines the sequence for the plurality of autonomous mobile robots to bring the plurality of master cases to the packing cell.
in response to instructions received from the control entity, selected autonomous mobile robots are further configured to retrieve a master case from a storage zone of the distribution center.
the storage zone includes an automated storage and retrieval system.
in response to instructions received from the control entity, selected autonomous mobile robots are further configured to bring the shipping case containing the one or more products contained in the customer order to an outfeed zone.
the packing cell includes a plurality of infeed zones for sequential placement of a plurality of master cases.
the robotic arm picks alternatively from the plurality of infeed zones from the plurality of master cases until all products, corresponding to the instructions received from the control entity have been picked and placed in the shipping case.
the packing cell includes a first infeed zone for placement of a first master case from the plurality of master cases, and a second infeed zone for placement of a second master case from the plurality of master cases.
in response to instructions received from the control entity, the selected autonomous mobile robots bringing the respective master cases to the packing cell, locate at queuing or pre-queuing areas of the packing cell.
the control entity causes the selected autonomous mobile robots bringing the respective master cases to the packing cell to locate in the pre-queuing area when carrying a master case that is required for the next customer order planned for the packing cell.
the control entity causes the selected autonomous mobile robots bringing the respective master cases to the packing cell to locate in the queuing area when carrying a master case that is required for the current customer order being fulfilled on the packing cell.
the control entity includes a machine-readable storage encoded with software for execution by the data processor.
a server arrangement implements the control entity.

In a broad non-limiting aspect, the disclosure relates to a method of fulfilling a customer order in a distribution center, the method comprising: a) receiving a customer order over a data network at a control entity that includes a data processor, the customer order identifying a plurality of different products being ordered, b) receiving instructions from the control entity at a packing cell configured to receive a plurality of master cases, each master case of the plurality of master cases holding a plurality of identical products, wherein the packing cell includes a robotic arm, and wherein in response to instructions received from the control entity the robotic arm is configured to pick and remove one or more products corresponding to the customer order from a relevant master case of the plurality of master cases and place into a shipping case, c) receiving instructions from the control entity at a plurality of autonomous mobile robots, wherein in response to the instructions received from the control entity, selected autonomous mobile robots of the plurality of autonomous mobile robots are configured to navigate in the distribution center to bring a respective master case to the packing cell, or to position in proximity to the packing cell to receive in the shipping case the one or more products picked by the robotic arm.

In some non-limiting embodiments, the method may include one or more of the following features:
the control entity receives a plurality of customer orders.
the control entity implements an ordering logic configured to receive and process the plurality of customer orders to obtain a corresponding plurality of order transactions.
the control entity processes the plurality of order transactions to fulfill the corresponding plurality of customer orders based on an optimization computation of resources properties.
the resources properties includes location of a master case containing a desired product unit, congestion in the distribution center, charge level of autonomous mobile robots, or status of the packing cell.
the control entity implements a packing arrangement logic to compute and determine a sequence for placing the one or more products in the shipping case.
the packing arrangement logic defines a position of each product in the shipping case.
the sequence for placing the one or more products in the shipping case determines the sequence for the plurality of autonomous mobile robots to bring the plurality of master cases to the packing cell.
in response to instructions received from the control entity, selected autonomous mobile robots are further configured to retrieve a master case from a storage zone of the distribution center.
the storage zone includes an automated storage and retrieval system.
in response to instructions received from the control entity, selected autonomous mobile robots are further configured to bring the shipping case containing the one or more products contained in the customer order to an outfeed zone.
the packing cell includes a plurality of infeed zones for sequential placement of a plurality of master cases.
the robotic arm picks alternatively from the plurality of infeed zones from the plurality of master cases until all products, corresponding to the instructions received from the control entity have been picked and placed in the shipping case.
the packing cell includes a first infeed zone for placement of a first master case from the plurality of master cases, and a second infeed zone for placement of a second master case from the plurality of master cases.
in response to instructions received from the control entity, the selected autonomous mobile robots bringing the respective master cases to the packing cell, locate at queuing or pre-queuing areas of the packing cell.
the control entity causes the selected autonomous mobile robots bringing the respective master cases to the packing cell to locate in the pre-queuing area when carrying a master case that is required for the next customer order planned for the packing cell.
the control entity causes the selected autonomous mobile robots bringing the respective master cases to the packing cell to locate in the queuing area when carrying a master case that is required for the current customer order being fulfilled on the packing cell.
the control entity includes a machine-readable storage encoded with software for execution by the data processor.
a server arrangement implements the control entity.

In a broad non-limiting aspect, the disclosure relates to a non-transitory computer-readable medium having instructions in code which when executed by a processor of a server acting as a control entity cause the server to: a) receive a customer order over a data network, the customer order identifying a plurality of different products being ordered, b) communicate instructions to a packing cell configured to receive a plurality of master cases, each master case of the plurality of master cases holding a plurality of identical products, wherein the packing cell includes a robotic arm, and wherein in response to the instructions, the robotic arm is configured to pick and remove one or more products corresponding to the customer order from a relevant master case of the plurality of master cases and place into a shipping case, c) communicate instructions to a plurality of autonomous mobile robots, wherein in response to the instructions, selected autonomous mobile robots of the plurality of autonomous mobile robots are configured to navigate in the distribution center to bring a respective master case to the packing cell, or to position in proximity to the packing cell to receive in the shipping case the one or more products picked by the robotic arm.

In some non-limiting embodiments, the non-transitory computer-readable medium having instructions in code which when executed by the processor of the server acting as the control entity may include one or more of the following features:
cause the server to receive a plurality of customer orders.
cause the server to implement an ordering logic configured to receive and process the plurality of customer orders to obtain a corresponding plurality of order transactions.
cause the server to process the plurality of order transactions to fulfill the corresponding plurality of customer orders based on an optimization computation of resources properties.
the resources properties includes location of a master case containing a desired product unit, congestion in the distribution center, charge level of autonomous mobile robots, or status of the packing cell.
cause the server to implement a packing arrangement logic to compute and determine a sequence for placing the one or more products in the shipping case.
the packing arrangement logic defines a position of each product in the shipping case.
the sequence for placing the one or more products in the shipping case determines the sequence for the plurality of autonomous mobile robots to bring the plurality of master cases to the packing cell.
in response to the instructions, selected autonomous mobile robots are further configured to retrieve a master case from a storage zone of the distribution center.
the storage zone includes an automated storage and retrieval system.
in response to the instructions, selected autonomous mobile robots are further configured to bring the shipping case containing the one or more products contained in the customer order to an outfeed zone.
the packing cell includes a plurality of infeed zones for sequential placement of a plurality of master cases.
cause the server to communicate instructions to the robotic arm to pick alternatively from the plurality of infeed zones from the plurality of master cases until all products, corresponding to the customer order have been picked and placed in the shipping case.
the packing cell includes a first infeed zone for placement of a first master case from the plurality of master cases, and a second infeed zone for placement of a second master case from the plurality of master cases.
cause the server to communicate instructions to the packing cell to locate at queuing or pre-queuing areas of the packing cell.
cause the server to communicate instructions to the selected autonomous mobile robots bringing the respective master cases to the packing cell to locate in the pre-queuing area when carrying a master case that is required for the next customer order planned for the packing cell.
cause the server to communicate instructions to the selected autonomous mobile robots bringing the respective master cases to the packing cell to locate in the queuing area when carrying a master case that is required for the current customer order being fulfilled on the packing cell.

All features of exemplary embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying Figures.

### BRIEF DESCRIPTION OF THE DRAWINGS

A detailed description of specific exemplary embodiments is provided herein below with reference to the accompanying drawings in which:

FIG. 1 conceptually illustrates a storage zone of a distribution site.

FIG. 2 conceptually illustrates various zones of a distribution center.

FIG. 3 illustrates shelf rakings included in the storage zone of FIG. 1, in accordance with an embodiment of the present disclosure.

FIG. 4 is a non-limiting illustration of an autonomous mobile robot (AMR) system including autonomous mobile robots and a packing cell, in accordance with an embodiment of the present disclosure.

FIG. 5 is a non-limiting top view illustration of a packing cell and autonomous mobile robots of FIG. 4 where the autonomous mobile robots bring a plurality of master cases to the packing cell, in accordance with an embodiment of the present disclosure.

FIG. 6 is a non-limiting functional block illustration of a control entity for operating the system to automate the distribution center, in accordance with an embodiment of the present disclosure.

FIG. 7 is a non-limiting flowchart of a process for processing a customer order, in accordance with an embodiment of the present disclosure.

FIG. 8 is a non-limiting flowchart of possible sub-steps of one step of the process of FIG. 7, in accordance with an embodiment of the present disclosure.

FIG. 9 is a non-limiting flowchart of possible sub-steps of another step of the process of FIG. 7, in accordance with an embodiment of the present disclosure.

FIGS. 10A-10E are non-limiting illustrations of possible product box placement in a virtual shipping case, in accordance with an embodiment of the present disclosure.

FIG. 11 is a non-limiting illustration of database entries mapping product combinations with packing arrangements, in accordance with an embodiment of the present disclosure.

FIG. 12 is a high-level block diagram illustration of a computer infrastructure for implementing the control entity, in accordance with an embodiment of the present disclosure.

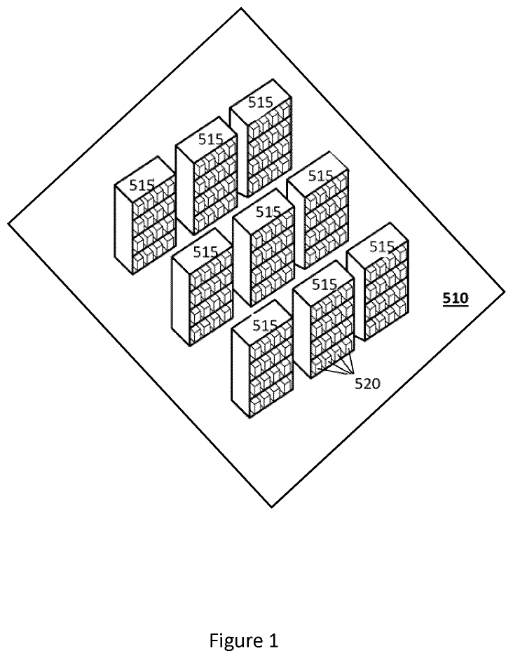

In the drawings, exemplary embodiments are illustrated by way of example. It is to be expressly understood that the description and drawings are only for the purpose of illustrating certain embodiments and are an aid for understanding. They are not intended to be a definition of the limits of the invention.

### DETAILED DESCRIPTION

The present technology is explained in greater detail below. This description is not intended to be a detailed catalog of all the different ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art considering the instant disclosure which variations and additions do not depart from the present technology. Hence, the following description is intended to illustrate some embodiments of the technology, and not to exhaustively specify all permutations, combinations, and variations thereof.

The present inventors have developed an automated system, devices, and method for warehouse and distribution centers relating to processing customer orders, including picking and packaging product units into shipping cases for shipment to customers. In particular, the automated system, devices, and method described herein allow processing customer orders relating to a set of different products units placed in the same shipping case. Advantageously, the system, devices, and method described herein can be implemented with minimal, or in some cases substantially without, human involvement (also referred herein as “automated actions”). Eventually, the shipping case is processed for shipping to the customer.

The system, devices, and method described herein afford one or more technical advantages as will be apparent to a person skilled in the art in view of the present disclosure.

For example, the system, devices, and method described herein may be integrated in a seamless fashion with existing enterprise infrastructure. For example, the system, devices, and method described herein may be customized or expanded according to business needs and/or market changes. For example, the system, devices, and method described herein may facilitate headcount reduction at a distribution site. For example, the system, devices, and method described herein may support inventory management. For example, the system, devices, and method described herein may improve flexibility to new categories (SKUs) and channels (delivery methods) over existing automation solutions available in the market. For example, the system, devices, and method described herein may support faster order processing.

In some embodiments, the system, devices and method described herein may be tailored to various plant configurations, independently of industry type, or application type required.

### Automated System

Various components and devices of an automated system in accordance with the present disclosure will now be described in further details.

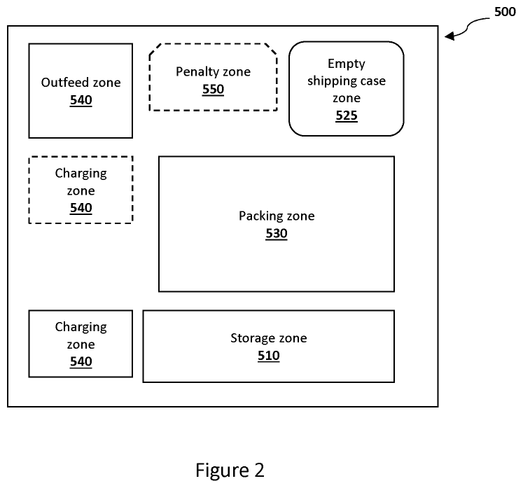

FIG. 2 is a non-limiting illustration of a distribution center 500 including one or more zone(s), which can be based on logistic or local requirements, and/or specific applications. For example, the distribution center 500 may include a storage zone 510, an empty shipping case zone 525, a packing zone 530 and an outfeed zone 540.

In some embodiments, the distribution center 500 may further include one or more optional additional zones based on logistic or local requirements, and/or specific applications. For example, the distribution center 500 may further include one or more optional charging zone 540. For example, the distribution center 500 may further include optional penalty zone 550.

As will be apparent to the reader in view of the present specification, each of the aforementioned zones may include one or more devices for performing the herein described operations.

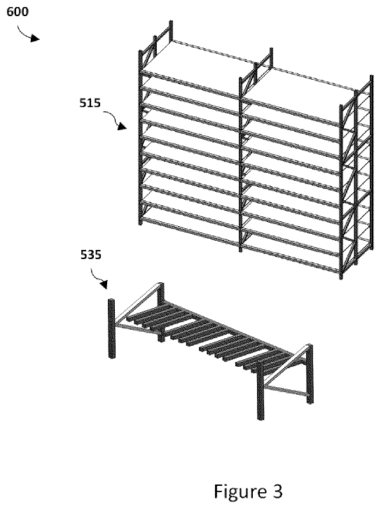

Storage zone 510 typically may include an automated storage and retrieval system (ASRS) 600, as shown in FIG. 3. For example, the ASRS 600 may include at least two sections—a first section comprising a plurality of high-rise shelves 515, and a second section comprising single shelf racking 525.

For example, the high-rise shelves 515 can be several feet or stories high with several rows or racks. The high-rise shelves 515 can be used to store slow and medium mover master cases 520. Each row or rack may include several master cases 520. The number of master cases 520 that can be placed along the depth direction on a given rack may be determined according to actual needs. For example, two master cases 520 or three master cases 520 or more can be placed. The number of master cases 520 placed along the depth direction on a given rack is not limited in the present application.

For example, the single shelf racking 525 can be used to store fast mover master cases 520 and as a buffer for other products. In most embodiments, the shelf racking 515 is fixed in place in a location inside the warehouse; however, in other embodiments, the shelf racking 515 may be movable, either in manually or automatically. In the latter case, shelf-racking 515 may includes wheels or rollers to displace the shelf racking. In one embodiment, the shelf racking 515 may be autonomously movable to automatically reconfigure the layout of the warehouse. In such an embodiment, the shelf racking may have a motor and sensors to displace the shelf racking 515. In some embodiments, the shelf racking 515 may be movable with the aid of the herein described autonomous mobile robots (described later).

A master case 520 typically stores quantities of products, articles or items having a single stock-keeping unit (SKU) product-identifying code or unique identifier). For example, a master case 520 may be a cardboard box or a plastic tote. A master case 520 may include a scan-readable label (e.g., a barcode, a QR code, etc.) allowing rapid identification for inventory management or localization purposes, for example. In some embodiments, the scan-readable label can be a one-dimensional (or 1D) barcodes, which represent data by varying the widths and spacing of parallel lines, such as UPC barcodes, EAN barcodes, Code128 barcodes, ITF-14 barcodes, Code39 barcodes, or the scan-readable label can be any other suitable barcode system. For example, the scan-readable label may include information relating to SKU number, lot number, virtual license plate number (LPN) to track, store and assign the product. In another embodiment, each master case 520 may be uniquely identified using RFID tags.

Empty shipping case zone 525 typically is where all cases used for the shipping are handled prior to be sent to the packing cell to fulfill the orders. Prior to their storage as shipping cases, the cases are identified with a label comprising a LPN and a barcode for identification and tracking within the system. Once the label is applied, the shipping case can be brought right away to the packing zone 530 for immediate use, or be stored in the empty shipping case zone 525 for later use. The shipping case is assigned to an order after it has received its LPN label. Single shelf racking can be used to store the empty shipping cases.

Penalty zone 550 typically is where cases causing errors and exceptions in the system are brought to this zone to be managed by an operator at a penalty box. The penalty box is used to extract a case from the system which has caused an error or if a problem occurred in the robotic picking cell. This case will be inspected by an operator. For example, an interface screen can be made available to the operator to indicate the issue found with the case. This will allow the operator to troubleshoot and solve the issue as well as correcting the situation with this particular case. In operation, a faulty case is displaced to the penalty zone 550, where the case moves to a barcode reader station to acquire case information through a barcode reader. The case information may include SKU number, Lot number, Shipping LPN number, etc. The case information is then sent to the control system to retrieve the reject reason, which can be displayed on an interface screen. In some embodiments, the penalty box may require human intervention, where a person would check the order to make sure that the correct products are being placed in the shipping case, re-arrange the products in the shipping case and then redirect the shipping case (e.g., carry or using an automated system) to the outfeed zone 540 so the shipping case can be shipped to the client.

In a non-limiting example of implementation, and with further reference to FIG. 4, the present disclosure provides an autonomous mobile robot (AMR) system 700.

An AMR is a type of robot that can understand and move through its environment independently. Advantageously, the AMR system 700 may use sensors, artificial intelligence, machine learning, and compute for path planning to interpret and navigate through their environment.

Advantageously, the AMR system 700 is untethered from wired power.

In some embodiments, the AMR system 700 is in selective communication with a control entity 1000 via a communication network. In response to control entity instructions received by the AMR system 700, the AMR system 700 is configured to perform one or more respective automated action(s).

For example, an automated action performed by the AMR system 700 may include selecting and retrieving a master case 520 in a zone of the distribution center 500 and displacing the master case 520 to another location within the same zone. For example, and automated action performed by the AMR system 700 may include selecting a master case 520 in a first zone of the distribution center 500 and displacing the master case 520 to a second zone of the distribution center 500. For example, and automated action performed by the AMR system 700 may include picking and removing product units from a master case 520 and placing the picked product units into a shipping case. For example, and automated action performed by the AMR system 700 may include displacing a shipping case from a first zone of the distribution center 500 to a second zone of the distribution center 500.

In some embodiments, the AMR system 700 includes an autonomous mobile robot 710. The autonomous mobile robot 710 is in selective communication with the control entity 1000 via a communication network. In operation, the control entity 1000 communicates instructions to the AMR system 700 in the form of computer signals. In response to the control entity 1000 instructions received by the AMR system 700, the autonomous mobile robot 710 is configured to perform an automated action, such as to select and retrieve a target master case 520 from the storage zone 510. For example, from a rack of a shelf 515.

The autonomous mobile robot 710 may include a mobile platform 715. In response to the control entity 1000 instructions received by the AMR system 700, the mobile platform 715 is configured to autonomously navigate in the distribution center, in particular in the storage zone 510. For example, the autonomous mobile robot 710 can move forward and backwards and rotate 90° or 180° in both directions. The autonomous mobile robot 710 may include telescopic arms 720 to reach elevated racks, for example on a storage shelf 515.

In some embodiments, the autonomous mobile robot 710 may include a range of different sensors of the same or of different modalities to create a representation of the environment, to determine the autonomous mobile robot 710 position within the storage zone 510, navigate within the storage zone 510 while avoiding obstacles and collisions, and identify shelves containing the target master case 520. For example, the sensors may include a camera that provides a 2D image of the environment. Multiple cameras may be provided to achieve a wide field of view of the environment, such as a 180° or 360° field of view. For example, the autonomous mobile robot 710 may include a depth camera, and may use QR code-based navigation to move around the storage zone 510. For example, the storage zone 510 may include QR codes located on the floor and/or other surfaces to enable such QR code-based navigation. Because the autonomous mobile robot 710 is equipped with sensors, if it experiences an unexpected obstacle while navigating its environment, such as a fallen box or a crowd of people, it will advantageously use a navigation technique, like collision avoidance to slow, stop, or reroute its path around the object and then continue with its task. Non-limiting examples of commercially available autonomous mobile robots having such features may include the RoboShuttle RS8-DA (GeekPlus Technology Co., China).

In some embodiments, in response to the control entity 1000 instructions received by the AMR system 700, the autonomous mobile robot 710 may be configured to travel within the storage zone 510 to the position of a target master case 520 containing a desired product unit and retrieve the target master case 520. For example, the autonomous mobile robot 710 may be configured to retrieve the target master case 520 from a shelf 515. For example, the computer signals may convey instructions to retrieve the target master case 520 and place it in a transitory storage shelf 535. In this respect, the autonomous mobile robot 710 may further include one or more telescopic components 725 configured to extend and secure the target master case 520. For example, the computer signals may convey instructions to retrieve the target master case 520 from bottom racks of a shelf 515 and place it on higher racks of the same or different shelf 515 for storage, e.g., when the target master case 520 is not needed soon. For example, the computer signals may convey instructions to retrieve the target master case 520 from the higher racks of a shelf 515 and placing it on a bottom rack of the same or different shelf 515, e.g., when the target master case 520 is needed soon.

In some embodiments, the AMR system 700 includes a plurality of autonomous mobile robots 710. The plurality of autonomous mobile robots 710 is in selective communication with the control entity 1000. In response to the control entity 1000 instructions received by the AMR system 700, selected autonomous mobile robot 710 from the plurality of autonomous mobile robots 710 are configured to perform the herein described automated actions thereof, e.g., select and retrieve one or more target master case(s) 520 from the storage zone 510, etc.

In some embodiments, the AMR system 700 further includes an autonomous mobile robot 730. The autonomous mobile robot 730 is in selective communication with the control entity 1000. In response to the control entity 1000 instructions received by the AMR system 700, the autonomous mobile robot 730 is configured to perform an automated action.

For example, an automated action performed by the autonomous mobile robot 730 may include to receive a case, such as a master case 520 or a shipping case 420, 420′, and to displace it in the distribution center 500. For example from a first zone to a second zone. For example, an automated action performed by the autonomous mobile robot 730 may include to bring a master case from the storage zone 510 to the packing zone 530. For example, an automated action performed by the autonomous mobile robot 730 may include to bring an empty case 420 from the empty shipping case zone 525 to the packing zone 530. For example, an automated action performed by the autonomous mobile robot 730 may include to bring a full shipping cases 420′ from the packing zone 530 to the outfeed zone 540. As illustrated in the figures, the autonomous mobile robot 730 is a different type of robot than the autonomous mobile robot 710.

The autonomous mobile robot 730 may include a mobile platform 735. In response to control entity 1000 instructions received by the AMR system 700, the mobile platform 735 is configured to autonomously navigate in the distribution center. For example, the autonomous mobile robot 730 can move forward and backwards and rotate 90° or 180° in both directions. The autonomous mobile robot 730 may include a support surface 740 for receiving thereon a master case 520, or a shipping case 420, 420′, or a lower shelf of a shelf racking 515 for moving same from one location to another location in the distribution center. The autonomous mobile robot 730 may be equipped with a box-lifting module 745 that can adjust the support surface 740 at a suitable height for distribution center operations, such as in any one of the storage zone 510, the empty shipping case zone 525, the packing zone 530, and the outfeed zone 540. For example, the box-lifting module 745 can be a scissor-lift type. Alternatively, the autonomous mobile robot 730 may be equipped with a fixed supporting column that maintains the support surface 740 at a fixed height (now shown). The support surface 740 may include one or more edges at a periphery thereof to prevent a case disposed thereon from falling off. Alternatively or additionally, the support surface 740 may include a vacuum device or suction device to exert a downward suction force on the underside of the master case to restrain the master case on the support surface 740. Optionally, the vacuum device or suction device may be actuated only when the autonomous mobile robot 730 accelerates or decelerates above a predetermined acceleration or deceleration threshold. Optionally, the vacuum device or suction device may be actuated only when the master case is below a predetermined weight threshold. Optionally, the vacuum device or suction device may be actuated only when the autonomous mobile robot 730 is transporting a master case containing fragile products. The vacuum device or suction device can optionally be maintained or deactivated when the autonomous mobile robot 730 has arrived at the packing cell 750. Optionally, the support surface 740 may be automatically inclined during acceleration and automatically reclined during deceleration to securely support the master case on the autonomous mobile robot 730.

In some embodiments, the autonomous mobile robot 730 may include a range of different sensors of the same or of different modalities to create a representation of the environment, to determine the autonomous mobile robot 730 position within the distribution center 500, and navigate within the distribution center 500 while avoiding obstacles and collisions. For example, the sensors may include a camera that provides a 2D image of the environment. Multiple cameras may be provided to achieve a wide field of view of the environment, such as a 180° or 360° field of view. For example, the autonomous mobile robot 730 may include a depth camera, and may use QR code-based navigation to move around the distribution center 500. For example, one or more zones in the distribution center may include QR codes located on the floor and/or other surfaces to enable such QR code-based navigation. Non-limiting examples of commercially available autonomous mobile robots having such obstacle-avoidance features may include the P series, e.g., P40, P500, P800, and P1200 from GeekPlus Technology Co. Because the autonomous mobile robot 730 is equipped with sensors, if it experiences an unexpected obstacle while navigating its environment, such as a fallen box or a crowd of people, it will advantageously use a navigation technique, like collision avoidance to slow, stop, or reroute its path around the object and then continue with its task.

In some embodiments, the autonomous mobile robot 730, which includes an onboard navigation processor or microcontroller for autonomous navigation and collision avoidance, reconfigures a collision-avoidance algorithm executing by the navigation processor based on the dimensions and/or weight of the master case of products that it is carrying. The autonomous mobile robot 730 may also optionally adjust a maximal acceleration and deceleration, as well as a maximum velocity, based on the dimensions and/or weight of the master case of products it is carrying. Reduced acceleration, deceleration and velocity can be used in determining travel times within the warehouse, thereby enabling more precise scheduling of the autonomous mobile robots within the fleet. In one embodiment, the autonomous mobile robot 730 carries only a single master case at a time. In another embodiment, the autonomous mobile robot 730 carries multiple master cases at a time. The multiple master cases may be of the same product or of different products.

For example, when picking a master case 520 from a single shelf racking 525, the autonomous mobile robot 730 will drive underneath the single shelf racking 525 and raise its box lifting-module, such that the support surface 740 will come underneath the master case 520 to support it. Once the support surface 740 is raised, the autonomous mobile robot 730 can drive away with the master case 520. The opposite process is performed when bringing a master case 520 to a given single shelf racking 525.

In some embodiments, the AMR system 700 includes a plurality of autonomous mobile robots 730. The plurality of autonomous mobile robots 730 is in selective communication with the control entity 1000. In response to the control entity 1000 instructions received by the AMR system 700 in the form of computer signals, selected autonomous mobile robots 730 from the plurality of autonomous mobile robots 730 are configured to perform the herein described automated actions thereof.

In some embodiments, one or more barcode reader can be used at a given station of a zone to read and validate the SKU of master cases 520 that are being introduced in the zone. For example, a reflective photocell can be installed upstream of the barcode reader to detect a given master case 520 on an autonomous mobile robot 730 when it arrives in the station and will trigger barcode reader activation. For example, the photocell can be any suitable photocell available on the market, such as for example the PZ-G41CP (Keyence, Canada). For example, when a barcode is not readable or absent, the given master case 520 can be sent to a penalty box in penalty zone 550.

While the autonomous mobile robot 710 and the autonomous mobile robot 730 are shown in FIG. 4 with wheels, the reader will readily understand that either or both the autonomous mobile robot 710 and the autonomous mobile robot 730 may be equipped with any other suitable locomotion means, such as tracks, robotic legs, etc.

In some embodiments, the AMR system 700 includes a packing cell 750 located in the packing zone 530. The packing cell 750 is in selective communication with the control entity 1000. The packing cell 750 is configured to receive a plurality of master cases 520. In operation, the control entity 1000 communicates instructions (e.g., in the form of computer signals) to the packing cell 750. For example, the control entity 1000 instructions may be derived from a customer order (e.g., an order transaction). In response to the control entity 1000 instructions, the packing cell 750 is configured to pick and remove one or more product units from one or more master case(s) 520 of the plurality of master cases 520 and places the one or more product units in a shipping case 420.

The packing cell 750 can be equipped with an industrial robot 755, a programmable logic controller (PLC), one or more barcode readers, and one or more vision systems. For example, the industrial robot can be a multiple-axis industrial robot, such as a 6-axis industrial robot. For example, a suitable multiple-axis industrial robot can be the IRB 1300-7/1.4 (ABB Ltd, Switzerland). For example, a suitable PLC can be the Compact GuardLogix 5069-L310ERMS2 (Allen-Bradley, United States). For example, a suitable barcode reader can be a Keyence SR-1000.

In some embodiments, the vision system is configured for detecting the product in a master case, sending position and orientation data to the industrial robot 755 to pick the product. For example, the vision system may acquire and provide information from the product state and position, such as “at least one pickable product”, “product detected, but path blocked by unrecognized object”, “no product recognized”, “empty”, etc.

Advantageously, the industrial robot 755 can be equipped with a vacuum switch and can detect if a product is dropped between the pick and the pack sequence. For example, the industrial robot 755 can be equipped with an arm, i.e., a robotic arm. For example, the robotic arm can have an end of arm tool (EOAT) designed to manipulate product units having one or more pre-determined sizes and shapes. In most embodiments, the industrial robot 755 is configured to pick (grip) a single product at a time although, in other embodiments, the industrial robot 755 may be configured to pick (grip) more than one product at a time, e.g. two identical small boxes from the same master case. In the latter instance, the packing algorithm is adjusted for the overall dimensions of the combined products being simultaneously manipulated.

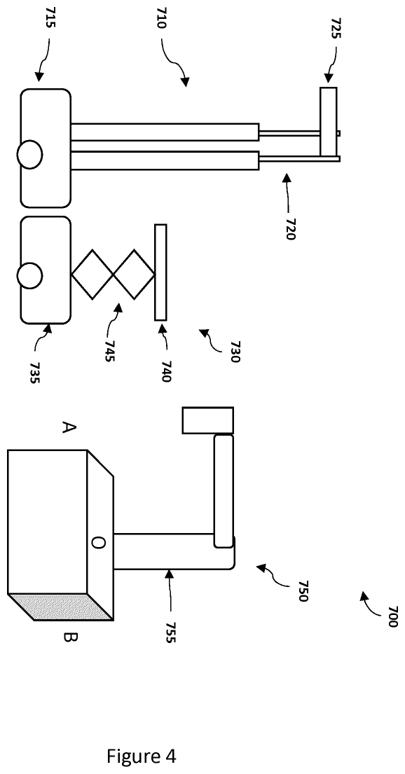

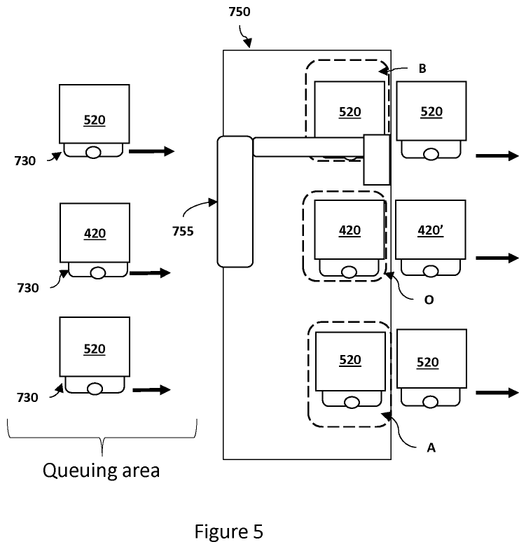

In some embodiments, a packing cell 750 may include a plurality of infeed zones. For example, the packing cell 750 may include two infeed zones (shown as A and B in FIG. 4 and FIG. 5) or more. In some embodiments, one vision system may be provided for each infeed zone.

In operation, the control entity 1000 sends instructions e.g., derived from an order transaction, to the AMR system 700. In response to the instructions received from the control entity 1000, the plurality of autonomous mobile robots making up the AMR system 700 navigate in the warehouse or distribution center, and bring a plurality of master cases 520 containing the products present in the order transaction to a packing cell 750 for placement in a shipping case 420 to fulfill the customer order.

In some embodiments, the AMR system 700 includes a plurality of packing cells 750 and a plurality of autonomous robots 710, 730 for simultaneously fulfilling a plurality of customer orders.

In some embodiments, in response to instructions received from the control entity 1000, selected autonomous mobile robots 730 are configured to navigate in the distribution center and bring a plurality of master cases 520 to a packing cell 750. In sequence or in parallel, selected autonomous mobile robots 730 are configured to navigate in the distribution center to acquire a position in proximity to the packing cell 750 to receive in a shipping case 420 the one or more products picked by the packing cell 750. In sequence or in parallel, selected autonomous mobile robots 730 are configured to navigate to the empty shipping case zone 525 to retrieve one or more empty case(s) 420, and bring the one or more empty case(s) 420 to the packing cell 750. In sequence or in parallel, selected autonomous mobile robots 730 are configured to displace the filled shipping case 420′ to another zone of the distribution center, such as the outfeed zone 540.

In some embodiments, in response to the instructions received from the control entity 1000, an industrial robot 755 is configured to pick one or more products from one or more master case(s) 520 of the plurality of master cases 520 to remove the one or more products therefrom. In response to the instructions received from the control entity 1000, the industrial robot 755 is configured to place the picked one or more products into a shipping case 420.

In some embodiments, in response to the instructions received from the control entity 1000, an autonomous mobile robot 730 is configured to bring an empty shipping case 420 to a packing cell 750 at a placement zone O. For example, a barcode reader, QR code reader or RFID reader can be used to identify the empty shipping case 420.

In some embodiments, the packing cell 750 may include a plurality of infeed zones for sequential placement of a plurality of master cases 520. In some embodiments, the industrial robot 755 (or the robotic arm or robotic manipulator) will pick alternatively from the plurality of infeed zones from the plurality of master cases 520 until all products, corresponding to the instructions received from the control entity 1000, have been picked and placed in a shipping case 420. In some embodiments, the industrial robot 755 will pick alternatively from the plurality of infeed zones, giving time to the autonomous mobile robots 730 from each infeed zone to move out and move in for the next pick on each infeed zones. When a plurality of units from a target product are needed, the autonomous mobile robot 730 located at said infeed zone will stay in position until the plurality of units from the target product for this sequence are picked and placed in the shipping case 420. Once units of the target product are not required anymore, the autonomous mobile robot 730 will move out of the pick position and let the following autonomous mobile robot 730 come to the pick position.

In some embodiments, the packing cell 750 may include a first infeed zone A for placement of a first master case 520 from the plurality of master cases 520, and a second infeed zone B for placement of a second master case 520 from the plurality of master cases 520. In response to the instructions received from the control entity 1000, a first autonomous mobile robot 730 is configured to bring the first master case 520 to the packing cell 750 at a picking position of the first infeed zone A, and a second autonomous mobile robot 730 is configured to bring the second master case 520 to the packing cell 750 at a picking position of the second infeed zone B.

In some embodiments, the autonomous mobile robot 730 carries the master case 520 all the way to the packing cell 750. In other embodiments, a first autonomous mobile robot 730 can hand off (transfer) the master case 520 to a second autonomous mobile robot 730 to complete the trip to the packing cell 750. This handoff procedure may be used, for example, if the first autonomous mobile robot 730 runs low on battery charge or if it begins to detect a malfunction. In another implementation, the handoff procedure may be useful for traffic congestion management. In yet another implementation, the handoff procedure may be used by the first autonomous mobile robot 730 to transfer one of two master cases it is carrying to the second autonomous mobile robot 730.

In some embodiments, in response to the instructions received from the control entity 1000, the industrial robot 755 is configured to pick one or more product unit(s) from the first master case 520 disposed on the first autonomous mobile robot 730 located in the picking position of the first infeed zone A. In some embodiments, a barcode scanner, QR scanner or RFID reader located in proximity to the infeed zone A scans and identifies the product picked from the first master case 520. Upon validation that the product picked is the expected one according to the instructions received from the control entity 1000, the industrial robot 755 then places (or drops) the product unit picked from the first master case 520 in the shipping case 420 located in zone O. In some embodiments, product orientation in the first master case 520 can facilitate picking of product units as it may allow the packing cell 750 to properly detect the product, pick it, identify it and place it in the shipping case 420. Once this is done, the industrial robot 755 picks one or more product unit(s) from the second master case 520 disposed on the second autonomous mobile robot 730 located in the picking position of infeed zone B. In some embodiments, a barcode scanner, QR scanner or RFID reader located in proximity to the infeed zone B scans and identifies the product unit picked from the second master case 520. Upon validation that the product unit picked from the second master case 520 is the expected one according to the instructions received from the control entity 1000, the industrial robot 755 then places (or drops) the product unit from the second master case 520 in the shipping case 420 located in zone O. In one embodiment, the industrial robot 755 further includes a weight sensor to sense a weight of the product that has been picked as a means to verify that the correct product has been picked. In one particular implementation, the industrial robot 755 includes one or more torque sensors on the motors or rotary actuators of the industrial robot 755. By sensing the torque on the motors or rotary actuators, the weight of the product unit can be computed. This can be used to verify or validate that the expected product has indeed been picked by the industrial robot 755.

As for infeed zone A, once the pick is completed therefrom, the first autonomous mobile robot 730 located therein moves out of the picking position of infeed zone A to let a subsequent autonomous mobile robot 730 come to the picking position in infeed zone A. As for infeed zone B, once the pick is completed therefrom, the autonomous mobile robot 730 located therein moves out of the picking position of infeed zone B to also let a subsequent autonomous mobile robot 730 come to the picking position in infeed zone B.

In some embodiments, when the shipping case has been filled with all product units corresponding to a customer order, the control entity 1000 instructs an autonomous mobile robot 730 to bring the filled shipping case 420′ to another zone in the distribution center, for example to the outfeed zone 540. For example, the shipping case 420 located at the placement zone O may be disposed on an autonomous mobile robot 730 while the packing cell 750 places the products from the plurality of master cases 520 into the shipping case 420.

The control entity 1000 then releases instructions to the AMR system 700 to fulfill the subsequent customer order, repeating the aforementioned operations.

In some embodiments, the packing zone 530 may include queuing and pre-queuing areas. In response to instructions received from the control entity 1000, the autonomous mobile robots 730 bringing plurality of master cases 520 to the packing cell 750 will locate at the queuing or pre-queuing areas to respect the picking sequence. For example, the queuing area can be located at or near an entry point of the packing cell 750. The control entity 1000 causes autonomous mobile robots 730 to locate in the queuing area when carrying master cases 520 for the current customer order being fulfilled on the packing cell 750. The pre-queuing area can be located further away from the entry point of the packing cell 750. The control entity causes autonomous mobile robots 730 to locate in the pre-queuing area when carrying master cases 520 that are required for the next order planned on the packing cell 750.

Advantageously, some formats of master cases 520 can be re-used as shipping cases 420 once they are empty. The other formats that cannot be re-used as shipping cases are rejected from the system.

In some embodiments, the distribution center 500 includes one or more charging zone(s) 540, which include one ore more charging stations for autonomous robots that are electrically powered. In a specific example of implementation, the autonomous robots are battery-powered, and the battery needs occasional re-charging. Once an autonomous mobile robot and/or the control entity 1000 senses the battery's charge level is low, the autonomous mobile robot navigates to the charging station and connects to a charging port, as per local instructions loaded on the autonomous mobile robot memory or as per instructions received from the control entity 1000. The charging can be wireless, e.g. inductive charging, to avoid physical, electrical connections between the autonomous robot and the charging station. Since the distribution center uses a fleet of autonomous mobile robots, a percentage of that fleet would be charging and would not be available for fulfilling customer orders. Once an autonomous robot is charging, it is functionally offline, and the online/offline status can be managed via wireless or wired communication with the control entity to make the control entity aware of which autonomous robot is available for customer order fulfillment or which one is not available as it is currently being charged.

### Control Entity

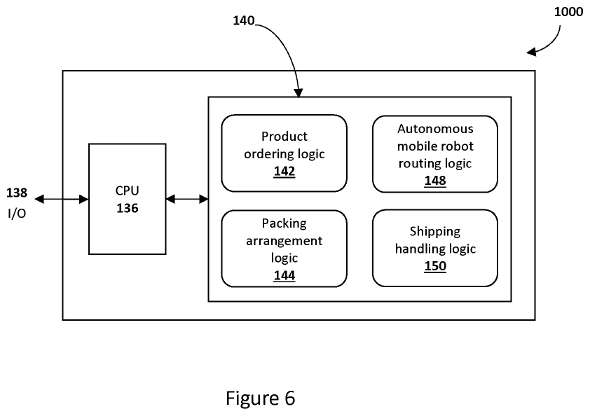

In a non-limiting implementation, and with further reference to FIG. 6, the control entity 1000 is computer-based, including a data processor and a machine-readable storage encoded with software for execution by the data processor. The software defines logic, which determines how the system described herein operates to automate the warehouse or distribution center.

Specifically, the control entity 1000 has an input/output (I/O) interface 138, at least one data processor 136 and a machine-readable storage, or memory, 140. The readable storage, or memory, 140 is encoded with software for execution by the data processor 136. The data processor 136 can be coupled to an Input/Output (I/O) interface 138 to allow the transfer of information to the outside world, such as external peripheral devices.

While FIG. 6 illustrates the control entity 1000 as being contained within a single computer device, the reader will readily understand that a network of computers, for example a server arrangement, can implement the control entity 1000. For example, each zone of the warehouse or distribution center may have one or more dedicated server(s) located therein, which are connected through wireless or wired connections with the other servers located in the other zones, together forming the control entity 1000. Server, computer, and computing machine are meant in their broadest sense, and can include any electronic device with a processor including cellular telephones, smartphones, portable digital assistants, tablet devices, laptops, notebooks, and desktop computers. Examples of computer-readable media include, but are not limited to, CD-ROMs, flash drives, RAM chips, hard drives, EPROMs, etc.

Referring back to the data storage 140, the software instructions provide a range of functions, which may include a product ordering logic block, or module 142, a packing arrangement logic, or module 144, an autonomous robot routing logic, or module 148, and a shipment handling logic, or module 150.

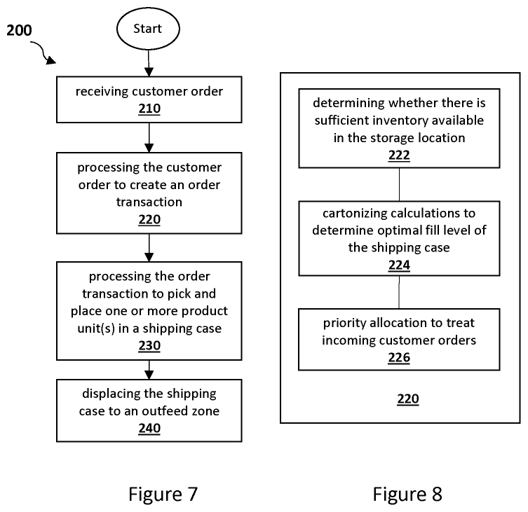

In some embodiments, and with further reference to FIG. 7, a non-limiting flow chart of illustrative process 200 implemented by the control entity 1000 is shown.

After the control entity 1000 is in an active state (generally represented by a “start” condition), the product ordering logic block, or module 142 of the control entity 1000 proceeds to receiving the customer order at step 210. Such customer order may be generated online, for example from the customer's enterprise resource planning (ERP) software system, and may be received at the warehouse or distribution center through a warehouse management system (WMS) software solution, for example. In some embodiments, such customer order may relate to a set of different product units (i.e., different SKUs). The logic of the control entity 1000 then proceeds to processing the customer order at step 220 to create an order transaction. In some embodiments, the customer order at step 220 includes a plurality of customer orders. In such embodiments, the product ordering logic block, or module 142 receives and processes the plurality of customer orders to obtain corresponding plurality of order transactions.

Typically, the product ordering block, or module, 142 can allow the customer to select products from a catalog to create a customer order and make a payment. The product ordering logic block, or module, 142 can also allow the customer to communicate with the warehouse or distribution center for order management purposes, such as modifying the order if the order has not been fulfilled yet and canceling the order, among others. For example, the product ordering logic block, or module 142 can also allow the customer to receive shipping information. For example, the product ordering logic module, or module, 142 can verify the inventory to determine if the products the client is ordering are available. If some products are unavailable, the product ordering logic block, or module, 142 may cause the action of advising the customer that some products are unavailable so that the order can either be canceled or modified.

In some embodiments, step 220 may include one or more additional steps as illustrated in FIG. 8. For example, step 220 may include determining whether there is sufficient inventory available in the storage location, at step 222.

In some embodiments, the packing arrangement logic, or module, 144 then proceeds to step 220 to compute and determine optimal fill level of the shipping case 420. For example, the packing arrangement logic, or module, 144 may compute cartonizing calculations step 224 at least based on filling criteria. For example, such filling criteria may include number and nature of product units, size of shipping cases 420 available, and the like. For example, when an order is received, the geometry of the various items in the order can be determined, and a packing sequence and product orientation in the shipping case 420 developed. Specifically, the packing arrangement logic, or module, 144 computes and determines the order in which the products will be picked and placed in the shipping case 420, i.e., a picking sequence. The packing arrangement logic, or module, 144 can also compute and determine the orientation of each product in the shipping case 420, in other words, the position of each product with relation to the other products. In the non-limiting embodiment of rectangular-shaped box products (e.g., cigarette cartons), the computation of the packing arrangement may involve extracting from the database 128 a 3D model of each box and virtually and iteratively arranging the 3D models to achieve the smallest overall volume, hence the most efficient packing arrangement. A factor to consider in the computation of the packing arrangement is the shipping case 420 boundary which provides boundary packaging constraints since the box sizes available for shipment of the customer orders are limited in number. That is to say, the packing arrangement logic, or module, 144 may initiate the computation by taking as a starting point a certain shipping case 420 size and try to virtually fit all the 3D models inside by iteratively re-arranging the packing order until a fit is achieved. If it is impossible to meet the box size constraints, the system moves to the next bigger shipping case 420 size and starts the process again. This is repeated until all the products can fit in the shipping case 420. The packing arrangement logic, or module, 144 can also compute and determine whether protective packing material such as a bubble wrap, foam, inflatable packing bags, etc. are to be inserted in the shipping case to properly protect the products during shipment. The packing arrangement logic, or module, 144 can make this determination based on a fragility index or fragility indicator associated with each product. The control entity 1000 may include a database of products and associated fragility indices and also optionally include a recommended type or size of protective packing material to be used. The size of the protective packing material is then used in determining the size of the shipping case and how to pack the products in the shipping case.

In some embodiments, the control entity 1000 processes the plurality of order transactions based on an optimization computation of resources properties. For example, the resources properties may include location of master cases 520 containing a desired product unit (e.g., on the floor or storage), congestion in the warehouse or distribution center (e.g., number of autonomous mobile robots present on the floor), charge level of autonomous mobile robots, status of the packing cell 750, and the like.

In some embodiments, step 220 may further include priority allocation step 226 to treat the incoming plurality of customer orders. For example, the priority allocation may be based upon a cut-off time for shipping out the warehouse and/or based upon an expected delivery time attached to each order. For example, each customer order from the plurality of customer orders may be allocated a numerical value (e.g., 1 to 10) that indicates its relative priority, or any other suitable value. Steps 222, 224, 226 may be performed sequentially, in any order, or in parallel.

In some embodiments, step 220 may break down the customer order into an order transaction, which may include the following information: a unique work order ID, shipping case 420 barcode, type of shipping case 420, shipping case 420 size, number of products in the order, pick sequence with the following information for each item: unique product identifier, e.g. product SKU, product dimensions, product weight, place coordinate position and orientation, approach vector, etc.

The control entity 1000 then proceeds to implement the order transaction to cause the system to pick and place one or more product unit(s) in a shipping case 420 at step 230. For example, the shipping case 420 may be a shipping tote or shipping box used as a container for the shipping order. For example, the shipping box may be made of corrugated cardboard. For example, the shipping tote may a plastic tote.

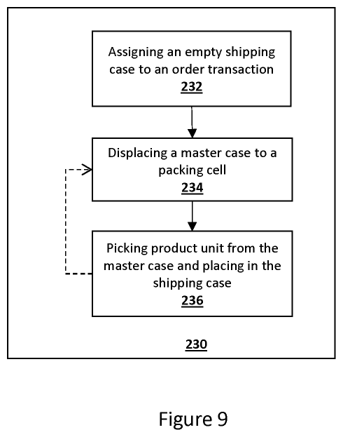

In some embodiments, step 230 may include one or more additional steps as illustrated in FIG. 9. For example, step 230 may include a step 232 of assigning an empty shipping case 420 to an order transaction. Step 230 may further include step 234 of displacing a master case 520 containing the target product unit to a packing cell 750 in the packing zone 530 at step 230, respecting the pick sequence.

In some embodiments, the master case 520 containing the desired product unit may be retrieved from its storage rack or may be already present on an autonomous mobile robot 730, for example. At step 234, any master case 520 containing the target product unit can be displaced based on throughput and convenience. For example. If a specific lot number or freshness rule is to be used, this requirement can be included in the processing step 220. For example, the master case 520 being retrieved may be one that contains sufficient units of the target product unit (SKU)—e.g., if a customer order indicates 10 units of a target SKU, the master case 520 being retrieved will be one that contains at least 10 units, such as for example 10, 15, 20 or more units.

In some embodiments, an artificial intelligence (AI) module, executed by the control entity 1000 or by another computing device may be used to learn which types and quantities of products tend to be ordered together. In so doing, the AI module may be able to recommend shipping case 420 sizes that are more optimally suited to the orders that are being currently received. The AI module may thus be able to recommend acquiring different box sizes, i.e. box sizes that are different from the currently supplied box sizes, that would be optimized for the combinations and quantities of products that are currently in the warehouse and being ordered. This optimization of shipping case 420 sizes may also be performed based on season (e.g. spring, summer, fall, and winter), customer geography, discounts or sales promotions or other market trends or factors. Another factor in determining the packing arrangement is the relative weight of the products. For certain products such as cigarette cartons, where the different carton brands weigh about the same, this is not a significant factor; however, for other products, where there may be a considerable weight difference between products in the order, it is desirable to place the heaviest products at the bottom. Otherwise, they may crush lighter products beneath them. The product weight can thus be another product characteristic available from the database, considered when computing the packing arrangement. The packing arrangement thus computed specifies the order in which the products are placed in the shipping case 420, namely product 1 goes first, followed by product 2, followed by product 3, etc. The product's position in the box is also specified for each product. For example, for the first product, the packing arrangement sets how the product fits in the box in terms of orientation and position.

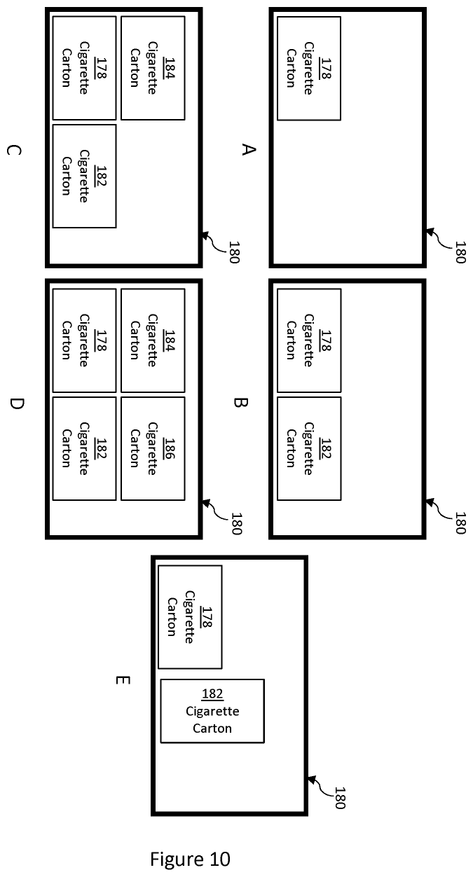

In the non-limiting practical implementation of a distribution center for rectangular-shaped product boxes (e.g., tobacco product cartons), the packing arrangement logic, or module, 144 may compute the positioning of the rectangular-shaped product boxes in a shipping case 420. For example, in the non-limiting embodiment of using 3D model, FIG. 10A shows an example of the virtual positioning of a 3D model of a rectangular-shaped product box 178 in a virtual shipping case 180. According to the computed packing arrangement, the rectangular-shaped product box 178 is placed at a location corresponding to the lower left quadrant in virtual shipping case 180. The position of the rectangular-shaped product box 178 can be defined in a coordinate system established by the internal shipping case volume. FIG. 10B shows the virtual placement of the rectangular-shaped product box 182. As in the case of the first rectangular-shaped product box 178, the position of the second rectangular-shaped product box 182 is also defined by its coordinates in the coordinate system of virtual shipping case 180. In the example shown, the virtual shipping case 180 is such that it cannot accommodate a row of three rectangular-shaped product boxes; hence the logic will place the next rectangular-shaped product box 184, in a different row, as shown in FIG. 10C. In FIG. 10D, yet another rectangular-shaped product box 186 is placed in virtual shipping case 180 to complete the first layer in the shipping case. Accordingly, the processing outputs a packing arrangement defining the order in which each product goes into the shipping case 420 and the position of each product, defined in terms of coordinates in the coordinate system of the shipping case 420.

A possible definition of the packing arrangement includes: the number of product layers in the shipping case 420; the identification of the products in the first layer, the second layer, etc.; each product's position and orientation in the first layer, the second layer, etc.; the sequence of placement of the products in each layer.

In some embodiments, the packing arrangement logic, or module, 144 may use the 3D model of each product and virtually assemble those to achieve the most efficient packing arrangement, one which requires the smallest shipping case 420 and leaves the least amount of void volume in the shipping case 420. For example, the product packing logic, or module, 144 can operate, as shown in FIGS. 10A-14D, by initially positioning one product in a virtual box and then trying to fit the other products in the remaining space by manipulating them to change their orientation to make them fit. For example, the product packing logic, or module, 144 can be configured to pick an orientation of the product in the imaginary plane corresponding to the bottom of the virtual shipping case 180 in FIGS. 10A-10D. In other words, the product packing logic, or module, 144 can be configured to perform virtually a rotation of the rectangular-shaped product box about an axis that is perpendicular to the imaginary plane. The first possible orientation is one where the longitudinal axis of the product is oriented horizontally. This would be the case for all the products shown in FIGS. 10A-10D. A second possible orientation is one where the longitudinal axis of the product is oriented vertically (with reference to the coordinate system of the box shown in FIGS. 10A-10D. FIG. 10E is an example of a packing arrangement where the virtual rectangular-shaped product box models are oriented according to different orientations in the virtual shipping case 180. The rectangular-shaped product box 178 is placed such that its longitudinal axis is along the horizontal axis (which corresponds to the X axis of the virtual shipping case 180 coordinate system), and the rectangular-shaped product box 182 is placed such that its longitudinal axis is oriented vertically (along the Y axis of the coordinate system of the virtual shipping case 180).

The examples of product orientations shown in FIGS. 10A-10E, are situations where the longitudinal axis of the product is aligned with the X or Y axes of the coordinate system of the virtual shipping case 180. It is also possible to orient the product in intermediate positions such that the longitudinal axis is at an angle other than 0° or 90°. Note that other product orientations are also possible, such as ones where the product is flipped on one of its sides. While such product re-positioning can be done virtually, it becomes complex to achieve with a robotic arm and may require a series of manipulations to achieve the desired orientation.

The packing arrangement logic, or module, 144 may also be configured to use pre-set packing arrangements determined previously for a range of different product combinations. For example, packing arrangement, or module, 144 maintains a database mapping product combinations with packing arrangements. When a customer order is received and before computation of the packing arrangement is initiated, the packing arrangement logic, or module, 144 searches the database to determine if such product combination has not been ordered previously and, in the affirmative, extracts the packing arrangement previously computed. This approach is faster and more effective than computing a packing arrangement every time. However, suppose the database search finds no previous product combinations corresponding to the customer order. In that case, the packing arrangement logic will perform a new computation described above and store it in the database. In this fashion, the database is updated and eventually would capture most, if not all, of the product combinations that customers can order.

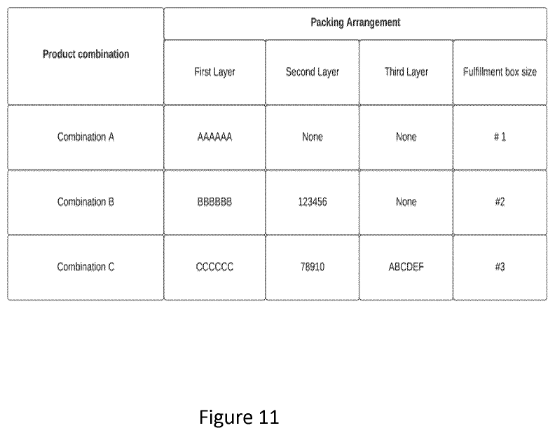

An example of the structure of such a database is shown in FIG. 11. For each combination, there is a packing arrangement definition which is organized by individual layers, where the definition of each layer provides the position of the product in a coordinate system, which can be the coordinate system of the shipping case 420, the orientation of the product, the order of placement of the products and an image of the first layer once all the products have been put in place. The image is a reference image that can be compared to the actual image of the first layer once the first layer is built into the shipping case 420 to determine if the first layer is correctly put together. The image can be synthetically generated from the virtual model assembled by the packing arrangement logic, or module, 144, or it can be a real image taken from a layer of actual products.

In some embodiments, the packing arrangement logic may be performed with a load planning module, such as for example Cube-IQ (MagicLogic, Canada).

### Autonomous Mobile Robot Routing Logic 148

Autonomous mobile robot routing logic, or module, 148 is designed to control and define the navigation of the autonomous robots in the warehouse or distribution center to allow the autonomous mobile robots to pick and place the products from the customer order in the correct sequence.

For example, the routing logic, or module, 148 can define a series of waypoints where a specific autonomous mobile robot must go to fulfill the customer order. For example, for a first product to go in a shipping case 420, the first waypoint would be the storage zone 510 to pick a master case 520 containing the desired first product, which would be located at specific coordinates in the warehouse or distribution center. For example, a second waypoint could be the packing zone 530, such as a pre-queuing area of a specific packing cell 750. For example, a third waypoint could be the queuing area of the specific packing cell 750. For example, a fourth waypoint could be an infeed zone (A or B) in the packing cell 750.

### Shipment Handling Logic 150

Shipment handling logic 150 defines various actions performed when an autonomous robot arrives with a filled shipping case 420′ at the outfeed zone 540.

In some embodiments, such various actions may include closing the filled shipping case 420′ and/or applying a shipping label with automated equipment. It will be noted that the autonomous robot and/or the filled shipping case 420′ can have a unique identifier allowing the control system to retrieve the correct customer order from the database. For example, the filled shipping case 420′ may have a bar code or QR code associated with the customer's order. A barcode reader or QR code reader at the outfeed zone 540 reads the code and retrieves from the shipment handling logic 150 the customer order and an associated shipping label, which is automatically printed and applied to the filled shipping case 420′. Alternatively, the autonomous mobile robot is configured to wirelessly communicate with a device in the outfeed zone 540 to transmit to such device a unique identifier assigned to the autonomous mobile robot when a customer order is assigned to it. Based on that unique identifier, the shipping label is created, and the filled shipping case 420′ can be shipped.

### Non-Limiting Practical Implementation

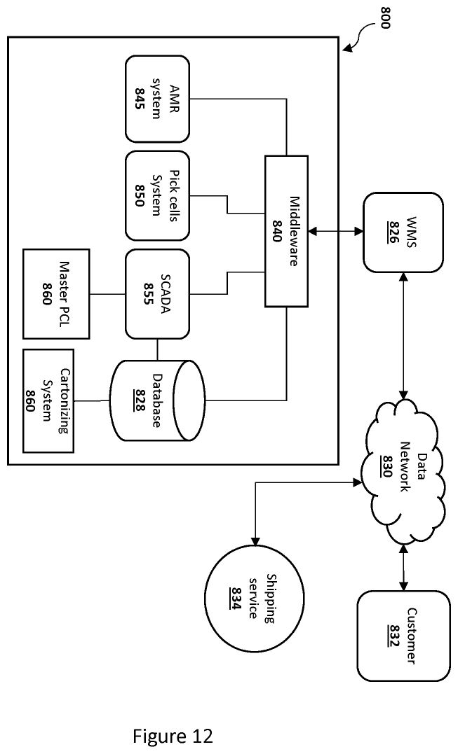

In some embodiments, the control entity 1000 can be implemented using a computer infrastructure 800 with the high-level block diagram illustration shown in FIG. 12. Such computer control entity infrastructure 800 may include various types of computer-readable mediums and interfaces that implement the operations described herein.

In some embodiments, the computer infrastructure 800 includes a middleware software 840 for connecting a warehouse management system (WMS) 826 to various sub-system modules. Optionally, the WMS 826 may be an integral part of the computer infrastructure 800. In some embodiments, the WMS 826 is a legacy system that was already in operation in the warehouse or distribution center to which, the herein described computer infrastructure and system is integrated for automation of the warehouse or distribution center.

In some embodiments, the sub-system modules may include an autonomous mobile robot (AMR) fleet manager 845, a packing cell system 850, a supervisory control and data acquisition (SCADA) system 855, a database 828, and a load planning module 860. The SCADA system 855 can be configured to exchange data with the WMS 826 (order lists, priority, inventory status, etc.) and transfer relevant information to the other sub-systems.

For example, the AMR fleet manager 845 may handle the autonomous mobile robots movement in the field. The AMR fleet manager 845 may program the movement paths, handle battery charging and optimize vehicle movements and priorities.

For example, the load planning module 860 may organize the products positions in the shipping cases 420. The load planning module 860 may feed the dimensions of the products and cases and optimize the positions and orientation of each product unit in the shipping case 420. This information is then fed to the AMR fleet manager 845 to bring the product master cases and shipping cases 420 in the right sequence to the packing cells 750. Packing cell system 850 will also receive this information for the industrial robot 755 of the packing cell 750 to be able to place the products in the shipping cases 420, according to the picking sequence.

For example, the database 828 can store characteristics of the distribution center or products stored therein. For example, inventory of product units, virgin cases, and shipping cases 420, inventory and status of AMR fleet, dimensions and overall geometry of product units, etc.

In some embodiments, storing dimensions and overall geometry of product units allows the load planning module 860 to compute a packing product pattern in a box for better packing efficiency. The product geometry can be expressed as any suitable 3D model, allowing the load planning module 860 to dynamically manipulate the models and re-arrange them to achieve an optimal packing pattern. Based on the computed packing pattern, the order in which the product units will be picked by the autonomous mobile robot system 700 can be determined and the placement (orientation) of the products in the shipping case 420 can also be determined.

The WMS 826 can be connected to a data network 830 such as the Internet. A customer at a remote location 832, which, as indicated previously can be a convenience store, places an order via an online ordering system by interacting with the WMS 826, for example via the customer's ERP software system.

At least some of the herein described steps can be implemented in digital electronic circuitry, in computer hardware, firmware, software, or in combinations of them. The implementation can be as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program, application or engine, or as a module, component, subroutine, or other unit suitable for use in a computing environment. A computer program can be deployed to be executed on one computer or on multiple computers at one site or distributed across multiple sites and interconnected by a communication network. Computer programs are configured to enable online and automated functions such as, for example, sending and receiving messages, receiving query requests, configuring responses, dynamically configuring user interfaces, requesting data, sending control instructions, receiving data, parsing data, displaying data, executing complex processes, interpreting scripts, constructing database queries, executing data base queries, executing simulations, calculations, forecasts, mathematical techniques, workflows and/or algorithms, prompting users, verifying user responses, initiating processes, initiating other computer programs, triggering downstream systems and processes, encrypting and decrypting.

Computer programs and other software elements may be loaded onto a general purpose computer, special purpose computer, or other programmable data processing apparatus to produce a machine, such that the instructions that execute on the computer or other programmable data processing means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified herein or in flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may refer to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. A computer comprises a processor for executing instructions and one or more memory devices for storing instructions and data. Generally, a computer also includes, or can be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computing device coupled to or communicating with a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The components of the system described herein can be interconnected by any form or medium of digital data communication, e.g., a communication network. Examples of communication networks include a local area network (“LAN”) and a wide area network (“WAN”), e.g., the Internet, and include both wired and wireless networks.

The computing system described herein can include clients and servers. A client and server are generally remote from each other and typically interact through a communication network. The relationship of client and server arises by virtue of computer programs running on the respective computers and having a client-server relationship to each other.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), Flash files or modules, FLEX, ActionScript, extensible markup language (XML), dynamic HTML, cascading style sheets (CSS), helper applications, plug-ins, and/or the like. A web site, server or computer program may include a web service which includes applications that are capable of interacting with other applications over a communications means, such as the Internet.

Other examples of implementations will become apparent to the reader in view of the teachings of the present description and as such, will not be further described here.

Note that titles or subtitles may be used throughout the present disclosure for convenience of a reader, but in no way these should limit the scope of the invention. Moreover, certain theories may be proposed and disclosed herein; however, in no way they, whether they are right or wrong, should limit the scope of the invention so long as the invention is practiced according to the present disclosure without regard for any particular theory or scheme of action.

All references cited throughout the specification are hereby incorporated by reference in their entirety for all purposes.

Reference throughout the specification to “some embodiments”, and so forth, means that a particular element (e.g., feature, structure, and/or characteristic) described in connection with the invention is included in at least one embodiment described herein, and may or may not be present in other embodiments. In addition, it is to be understood that the described inventive features may be combined in any suitable manner in the various embodiments.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

Although various embodiments of the disclosure have been described and illustrated, it will be apparent to those skilled in the art considering the present description that numerous modifications and variations can be made. The scope of the invention is defined more particularly in the appended claims.

1. An automated system for use in a distribution center, comprising:
a) a control entity including a data processor for receiving a customer order via data communication over a data network, the customer order identifying a plurality of different products being ordered,
b) a packing cell configured to receive a plurality of master cases, each master case of the plurality of master cases holding a plurality of identical products, wherein the packing cell includes a robotic arm, wherein in response to instructions received from the control entity, the robotic arm is configured to pick and remove one or more products corresponding to the customer order from a relevant master case of the plurality of master cases and place into a shipping case, and
c) a plurality of autonomous mobile robots, wherein in response to instructions received from the control entity, selected autonomous mobile robots of the plurality of autonomous mobile robots are configured to navigate in the distribution center to bring a respective master case to the packing cell, or to position in proximity to the packing cell to receive in the shipping case the one or more products picked by the robotic arm.

2. The system of claim 1, wherein the control entity receives a plurality of customer orders.

3. The system of claim 2, wherein the control entity implements an ordering logic configured to receive and process the plurality of customer orders to obtain a corresponding plurality of order transactions.

4. The system of claim 3, wherein the control entity processes the plurality of order transactions to fulfill the corresponding plurality of customer orders based on an optimization computation of resources properties.

5. The system of claim 4, wherein the resources properties includes location of a master case containing a desired product unit, congestion in the distribution center, charge level of autonomous mobile robots, or status of the packing cell.

6. The system of claim 1, wherein the control entity implements a packing arrangement logic to compute and determine a sequence for placing the one or more products in the shipping case.

7. The system of claim 6, wherein the packing arrangement logic defines a position of each product in the shipping case.

8. The system of claim 6, wherein the sequence for placing the one or more products in the shipping case determines the sequence for the plurality of autonomous mobile robots to bring the plurality of master cases to the packing cell.

9. The system of claim 1, wherein in response to instructions received from the control entity, selected autonomous mobile robots are further configured to retrieve a master case from a storage zone of the distribution center.

10. The system of claim 9, wherein the storage zone includes an automated storage and retrieval system.

11. The system of claim 1, wherein in response to instructions received from the control entity, selected autonomous mobile robots are further configured to bring the shipping case containing the one or more products contained in the customer order to an outfeed zone.

12. The system of claim 1, wherein the packing cell includes a plurality of infeed zones for sequential placement of a plurality of master cases.

13. The system of claim 12, wherein the robotic arm picks alternatively from the plurality of infeed zones from the plurality of master cases until all products, corresponding to the customer order have been picked and placed in the shipping case.

14. The system of claim 13, wherein the packing cell includes a first infeed zone for placement of a first master case from the plurality of master cases, and a second infeed zone for placement of a second master case from the plurality of master cases.

15. The system of claim 1, wherein in response to instructions received from the control entity, the selected autonomous mobile robots bringing the respective master cases to the packing cell, locate at queuing or pre-queuing areas of the packing cell.

16. The system of claim 15, wherein the control entity causes the selected autonomous mobile robots bringing the respective master cases to the packing cell to locate in the pre-queuing area when carrying a master case that is required for the next customer order planned for the packing cell.

17. The system of claim 15, wherein the control entity causes the selected autonomous mobile robots bringing the respective master cases to the packing cell to locate in the queuing area when carrying a master case that is required for the current customer order being fulfilled on the packing cell.

18. The system of claim 1, wherein the control entity includes a machine-readable storage encoded with software for execution by the data processor.

19. The system of claim 18, wherein a server arrangement implements the control entity.

20.-55. (canceled)

56. An automated system, comprising
a) a control entity including a data processor for receiving via data communication over a data network a customer order, the customer order identifying a plurality of different products being ordered,
b) a packing cell having a robotic arm, and
c) a plurality of autonomous mobile robots,
wherein the control entity releases instructions to the plurality of autonomous mobile robots such that selected autonomous mobile robots retrieve and bring a plurality of master cases to the packing cell, each master case of the plurality of master cases holding a plurality of identical products, and
wherein the control entity releases instructions to the packing cell to direct the robotic arm to pick and place one or more products from the plurality of master cases into a shipping case.
